(19) United States
(12) Patent Application Publication
(10) Pub. No.: US 2023/0132677 A1
(43) Pub. Date: May 4, 2023

(54) STATIC DISCHARGE ELEMENT FOR A TIRE

(71) Applicant: The Goodyear Tire & Rubber Company, Akron, OH (US)

(72) Inventor: Michael Joseph Durr, Stow, OH (US)

(21) Appl. No.: 17/517,961

(22) Filed: Nov. 3, 2021

(51) Int. Cl. B60C 19/08; B60C 7/14

(52) U.S. Cl. CPC B60C 19/08; B60C 7/146

(57) ABSTRACT

A tire includes a cylindrical hub with a central axis, an annular supporting structure disposed radially outward from the hub, an annular shearband disposed radially outward from the supporting structure, an annular tread disposed radially outward from the shear band, and a conductive ink collectively applied to the shearband, supporting structure, and the hub to create a path for the discharge of electricity through the conductive ink. The conductive ink provides a substrate for conducting electricity with up to 50 percent strain applied to the substrate.

### FIELD OF THE INVENTION

The present invention relates generally to a pneumatic or non-pneumatic tire that has a static discharge element for reducing or eliminating static electrical charges. More particularly, the present invention defines a static discharge element that is electrically conductive to allow an electric charge to pass from a hub to tread of the tire and from the tread to the ground surface.

### BACKGROUND OF THE INVENTION

A conventional non-pneumatic tire for a vehicle may include an inner hub, sometimes referred to as a wheel, surrounded circumferentially by an radially outer disposed tread that includes an annular shear band. The inner hub may be made of metal and have a high degree of conductivity. The non-pneumatic tire may include a series of spokes that are disposed radially between the inner hub and the tread. The spokes can be made of polyurethane and cycle between tension and compression upon every revolution of the tire. A shear band may also be included within the non-pneumatic tire and be located radially between the spokes and the tread.

As this type of non-pneumatic tire rotates under load, the spokes experience bending, extension, and compression deformation when they are located downward near the contact patch of the tread. The spokes straighten outside the contact patch relieving the bending and compression deformation. The spokes thus experience cyclic deformation as the tire rotates. These repeated deformation cycles may cause fatigue in the spokes and limit the life of the spokes and the non-pneumatic tire.

Vehicles may accumulate static electrical charge when driven. If there is sufficient electrical conductivity between the vehicle and ground through the wheels and tires, the charge may be continually discharged, or depleted. However, if the electrical resistance between the ground and vehicle through the wheels and tires is too great, the vehicle may retain an electrical charge for a significant amount of time once the vehicle has stopped moving. In such a case, a person may be shocked when touching the vehicle such as when he or she grasps the door handle to open or close the door. It is known to incorporate a material called carbon black into the rubber of tires in order to provide electrical conductivity through the tire to prevent or reduce shock. The addition of carbon black to the sidewalls of tires may disadvantageously increase hysteresis, rolling resistance, and/or heat generation.

One conventional design may provide an electrical path through a tire. An electrically conductive cord may be placed between a bead region and a tread region extending from one bead of the tire to another bead of the tire. The cord may be located between a cord reinforced rubber carcass ply and an outer visible rubber layer of a sidewall of the tire. The cord may include a stainless steel wire helically wound around a core of polyester fiber. The stainless steel wire itself is inextensible, but the helical configuration allows it to be dynamically extended and flexed. As such, there remains room for innovative improvement within this technology.

### SUMMARY OF THE INVENTION

A first tire in accordance with the present invention includes a cylindrical hub with a central axis, an annular supporting structure disposed radially outward from the hub, an annular shearband disposed radially outward from the supporting structure, an annular tread disposed radially outward from the shear band, and a conductive ink collectively applied to the shearband, supporting structure, and the hub to create a path for the discharge of electricity through the conductive ink. The conductive ink provides a substrate for conducting electricity with up to 50 percent strain applied to the substrate.

According to another aspect of the first tire, the conductive ink includes silver particles.

According to still another aspect of the first tire, the conductive ink includes carbon particles.

According to yet another aspect of the first tire, the conductive ink includes carbon and silver particles.

A second tire in accordance with the present invention includes a cylindrical wheel with a central axis, at least two sidewall structures disposed radially outward from the hub, an annular belt package disposed radially outward from the sidewall structures, an annular tread disposed radially outward from the belt package, and a conductive ink collectively applied to the belt package, both sidewall structures, and the wheel to create a path for the discharge of electricity through the conductive ink. The conductive ink provides a substrate for conducting electricity with up to 50 percent strain applied to the substrate.

According to another aspect of the second tire, the conductive ink includes silver particles.

According to still another aspect of the second tire, the conductive ink includes carbon particles.

According to yet another aspect of the second tire, the conductive ink includes carbon and silver particles.

### BRIEF DESCRIPTION OF THE DRAWINGS

A full and enabling disclosure of the present invention, including the best mode thereof, directed to one of ordinary skill in the art, is set forth more particularly in the remainder of the specification, which references the appended Figures, in which:

FIG. 1 is a schematic perspective view of an example tire for use with the present invention.

FIG. 2 is a schematic side view of the tire of FIG. 1.

FIG. 3 is a schematic front view of the tire of FIG. 1.

FIG. 4 is a schematic cross-sectional view taken along line 4-4 of FIG. 3.

FIG. 5 is a schematic cross-sectional view of a portion of the tire of FIG. 1.

FIG. 6 is a schematic cross-sectional view of another portion of the tire of FIG. 1.

FIG. 7 is a schematic side view of a portion of another example tire for use with the present invention.

FIG. 8 is a schematic side view of a portion of still another example tire for use with the present invention.

FIG. 9 is a schematic side view of a portion of yet another example tire for use with the present invention.

Repeated use of reference characters in the present specification and drawings is intended to represent the same or analogous features or elements of the present invention.

### DETAILED DESCRIPTION OF EXAMPLES OF THE PRESENT INVENTION

Reference will now be made in detail to examples of the present invention, one or more examples of which are illustrated in the above-described drawings. Each example is provided by way of explanation of the present invention, and not meant as a limitation of the present invention. For example, features illustrated and/or described as part of one example may be used with another example to yield still a third example. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5. U.S. Pat. No. 9,027,615, hereby incorporated herein in its entirety, describes a representative example pneumatic tire for use with the present invention and U.S. Pat. No. 10,926,581, hereby incorporated herein in its entirety, describes a representative example non-pneumatic tire for use with the present invention.

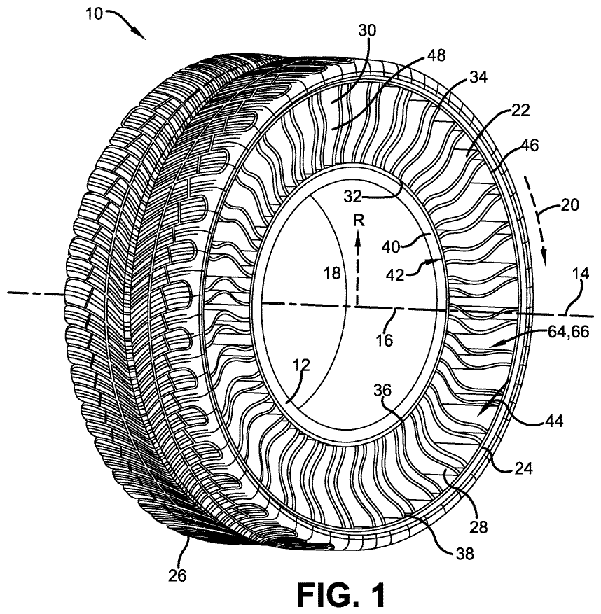

As shown in FIG. 1, an example non-pneumatic tire 10 for use with the present invention may have a static discharge element 30 for use in conducting electricity through the tire 10 to prevent or reduce the chances of shocking a person touching the vehicle and to remove unwanted static electricity from the vehicle. The static discharge element 30 may be located at the supporting structure 22 of the non-pneumatic tire 10 in order to transfer the electricity across the supporting structure 22. The supporting structure 22 may be constructed of materials that have poor electrically conductive properties. The static discharge element 30 may be electrically conductive and may be made in a variety of manners. In some examples, the static discharge element 30 may be elastic so that it may deflect with supporting structures 22 that are likewise elastic.

The non-pneumatic tire 10 may have an axis of rotation about the central axis 14. The central axis 14 may extend in an axial direction 16 of the tire 10. The central axis 14 may extend through an opening of a hub 12 of the tire 10. The radial direction of the tire 10 may be oriented at a perpendicular angle to the central axis 14, such that the hub 12 is spaced radially inwards from other portions of the tire 10, such as the supporting structure 22 and the tread 16. The non-pneumatic tire 10 may also have a circumferential direction 20 about which various portions of the tire 10 extend. For example, the tread 26, shear band 24, supporting structure 22, and hub 12 may all extend 360 degrees in the circumferential direction 20 about the central axis 14.

The supporting structure 22 may engage the hub 12 and be located outward from the hub 12 in the radial direction 18. The supporting structure 22 may include a series of spokes 28 extending from the hub 12 to the shear band 24 in the radial direction 18. It is to be understood that the supporting structure 22 need not include spokes 28. For example, the supporting structure 22 may be made of a series of elements arranged into a honeycomb like structure that extends 360 degrees about the central axis 14. In another example, the supporting structure 22 may be a solid member that extends 360 degrees about the central axis 14 in the circumferential direction 20.

The supporting structure 22 may have a first radial end 32 at the hub 12 that coincides with a first radial terminal end 36 of the spoke 28. The spoke 28 may extend in the radial direction 18 to the shear band 24, in which a second radial end 34 of the supporting structure 22 may be located. As the spoke 28 terminates at/in the shear band 24, the second radial terminal end 38 of the spoke 28 may similarly be located at the second radial end 34. The shear band 24 may be located outward from the various spokes 28 in the radial direction 18 and may extend 360 degrees about the central axis 14 in the circumferential direction 20. The tread 26 of the example non-pneumatic tire 10 may be outward from the shear band 24 in the radial direction 18 and may extend completely around the central axis 14 in the circumferential direction 20.

The static discharge element 30 may be located inside of the spoke 28 and may extend from the hub 12 through the spoke 28 to the shear band 24. The static discharge element 30 may also be located inside of the hub 12 and/or the shear band 24. In other examples, the static discharge element 30 may engage the hub 12 and shear band 24 and may not be inside of these elements 12, 24. Electricity may thus be transferred/conducted from the hub 12 to the shear band 24 through the spokes 28 via the static discharge element 30. Alternatively, the static discharge element 30 may be located at or between the first and second radial terminal ends 36, 38, and not extend radially outward past the second radial terminal end 38 and/or not extend radially inward past the first radial terminal end 36.

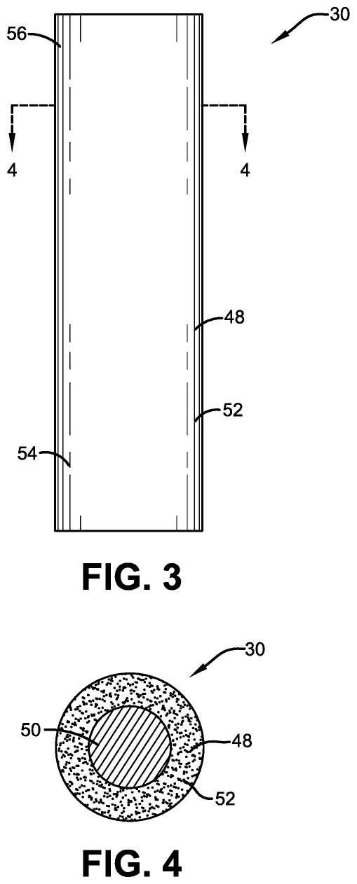

The static discharge element 30 may be a filament 48 that is a slender, thread-like object (FIGS. 3 and 4). The filament 48 may have a circular cross-sectional shape or other suitable cross-sectional shape. The filament 48 may include a polymeric strand 50 with a conductive carbon element 52. The conductive carbon element 52 may coat the length of the polymeric strand 50 so as to cover the entire length of the polymeric strand 50. In some examples, the conductive carbon element 52 may also coat the terminal top end and terminal bottom end of the polymeric strand 50 so that the polymeric strand 50 is completely covered on all sides by the conductive carbon element 52. In other examples, the polymeric strand 50 may be suffused with the conductive carbon element 52. The polymeric strand 50 may have a circular cross-sectional shape and the conductive carbon element 52 may have an annular cross-sectional shape with an inner void of circular cross-sectional shape filled with the circular polymeric strand 50. The filament 48 may include any type of conductive particles to enable electrical conductivity. For example, the conductive particles may be powdered copper. The electrically conductive particles may be infused within other portions of the filament 48.

The polymeric strand 50 may be a synthetic polymer, such as synthetic rubber, phenol formaldehyde resin, neoprene, nylon, polyvinyl chloride polystyrene, polyethylene, polypropylene, polyacrylonitrile, silicone, polyethylene terephthalate (PET), aramid, and/or hybrids of these. The polymeric strand 50 may also be a natural polymeric material, such as natural rubber. The filament 48 may be configured as a monofilament, a multifilament yarn, a staple, and/or other solid configuration.

The spoke 28 may flex during rotation of the tire 10 and the spoke 28 may have an elongation of 10 percent, 0-4 percent, 4-5 percent, 5-15 percent, 8-12 percent, 9-11 percent, 10-13 percent, 10-15 percent, 15-25 percent, up to 30 percent, or up to 50 percent. The filament 48 may have an elongation that is at least 10 percent, so that the filament 48 may likewise be capable of stretching to accommodate stretching of the spoke 28 into/onto which it is carried. The electrical conductivity of the static discharge element 30 may be greater than that of the spoke 28 so that electricity more easily flows through the static discharge element 30 than the spoke 28. The spoke 28 may be made of polyurethane and thus may not have adequate electrical conductivity.

One exemplary filament 48 may be a 22-denier nylon 6 monofilament 50 which has electrically conductive carbon 52 suffused onto the surface of the monofilament 50. The filament 48 may have a round cross-section and the conductive carbon element 52 may have a thickness of 1 micron on the monofilament 50. The tenacity of this filament 48 may be 5 grams/denier, the elongation at break may be 41 percent, and the average electrical resistivity may be 5 ohms/centimeter. The suffusion process may chemically saturate the outer skin of the nylon monofilament 50 with the electrically conductive carbon particles 52. The conductive carbon particles 52 may become part of the structure of the nylon monofilament 50 while retaining the strength and flexibility of the nylon monofilament 50. The suffusion process may result in a filament 48 with a durable, conductive sheath that does not crack or lose conductivity during flexing.

Although described as having a conductive carbon element 52 in the filament 48, other types of electrically conductive carbon may be included, such as carbon nanotube (CNT), graphite, graphene, and/or carbon black. Further, although described as having electrically conductive carbon in the filament 48, other types of metallic fillers may be used for the purpose of conducting electricity through the filament 48.

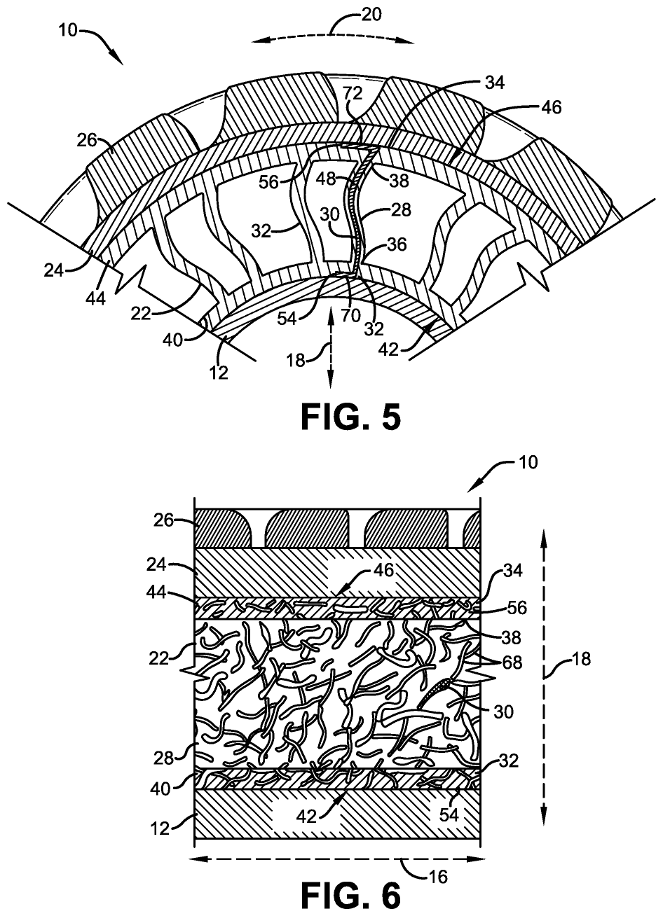

As shown in FIG. 5, the spoke 28 may include an arc-length portion of the tire 10 in the circumferential direction 20. The supporting structure 22 may include an inner interface ring 40 and an outer interface ring 44 disposed outward from the inner interface ring 40 in the radial direction 18. The supporting structure 22 may further include a plurality of spokes 28 that engage both the inner and outer interface rings 40, 44. The first radial end 32 of the supporting structure 22 may be the inner interface ring 40 and the second radial end 34 of the supporting structure 22 may be the outer interface ring 44. The first radial terminal end 36 of the spoke 28 may be located at the inner interface ring 40 and the second radial terminal end 38 of the spoke 28 may be located at the outer interface ring 44.

The filament 48 may extend through the interior of the spoke 28 and also may extend through the inner interface ring 40 and the outer interface ring 44. A first end 54 of the filament 48 may extend some distance in the circumferential direction 20 along a first terminal end 42 of the inner interface ring 40. The first end 54 may be located between the first terminal end 42 and the hub 12. Adhesive 70 may be applied to the first end 54 and the hub 12 to attach these two elements. The adhesive 70 may be electrically conductive in order to allow electricity to flow from the hub 12 into the first end 54 of the static discharge element 30. The adhesive 70 may have a concentration of carbon black with 23 percent weight, or may have a concentration of graphene of 2 percent weight. Although described as being connected through the use of adhesive 70, any other form of attachment of the first end 54 may be implemented. A mechanical connection may be used to attach the first end 54 of the filament 48 to the hub 12 or to the inner interface ring 40. The mechanical connection can be electrically conductive as well in order to allow electricity to flow through the hub 12 to the first end 54. The connection need not be electrically conductive if the first end 54 is placed against the hub 12 to cause electrical connectivity between the first end 54 and the hub 12.

The second end 56 may extend along a length of a second terminal end 46 of the outer interface ring 44 in the circumferential direction 20. The second end 56 may be located between the second terminal end 46 and the shear band 24. Adhesive 72, that can be electrically conductive as described above with respect to adhesive 70, may be used to attach the second end 56 to the shear band 24. As with the first end 54, other types of connection, such as a mechanical connection, may be used to attach the second end 56 to the shear band 24. Electricity from the filament 48 may flow through the second end 56 and the electrically conductive adhesive 72 into the shear band 24 for subsequent discharge from the non-pneumatic tire 10. The adhesive 70, 72 need not be used and the ends 54, 56 may be placed into engagement with the hub 12 and shear band 24 by other means. Further, although described as going through the interiors of the outer interface ring 44, the spoke 28, and the inner interface ring 40, the filament 48 may be on the outside of one or more of these components in other configurations of the non-pneumatic tire 10.

As shown in FIG. 6, an alternative arrangement of an example non-pneumatic tire 10 may include a static discharge element 30 including a filament fiber filler 68 injected into the other material of the supporting structure 22. The supporting structure 22 may have an inner interface ring 40, an outer interface ring 44, and a plurality of spokes 28. These components 28, 40, 44 may be constructed of polyurethane with a filler made up of the filament fibers 68. The filament fibers 68 may be mixed into the polyurethane and distributed about the components 28, 40, 44. In other examples, the components 28, 40 and 44 and any other portions of the supporting structure 22 may be made of reinforced and/or non-reinforced material, such as a polymeric material. The polymeric material may be polyurethane, co-polyester, polyether block amide, and/or polyolefins. Still further, other examples of the non-pneumatic tire 10 as described herein may include components, such as the spoke 28, the inner interface ring 40, the outer interface ring 44, and the supporting structure 22, with different types of polymeric materials.

The filament fibers 68 may be from 2-7 millimeters in length and may have characteristics similar to the filament 48 previously discussed with regard to electrical conductivity and elasticity. The spoke 28 may thereby be capable of flexing a required amount while still conducting electricity through the spoke 28 as the overlapping filament fibers 68 form a pathway through which electricity may flow through the components 40, 28, 44. The filament fibers 68 may be placed into the supporting structure 22 throughout the entire supporting structure 22 so that the filament fibers 68 may be disposed 360 degrees around the supporting structure 22 in the circumferential direction 20. Alternatively, the filament fibers 68 may be placed into only a section of the supporting structure 22 with only an arc length of the supporting structure 22 conducting electricity in the circumferential direction 20, and not 360 degrees around the central axis 14.

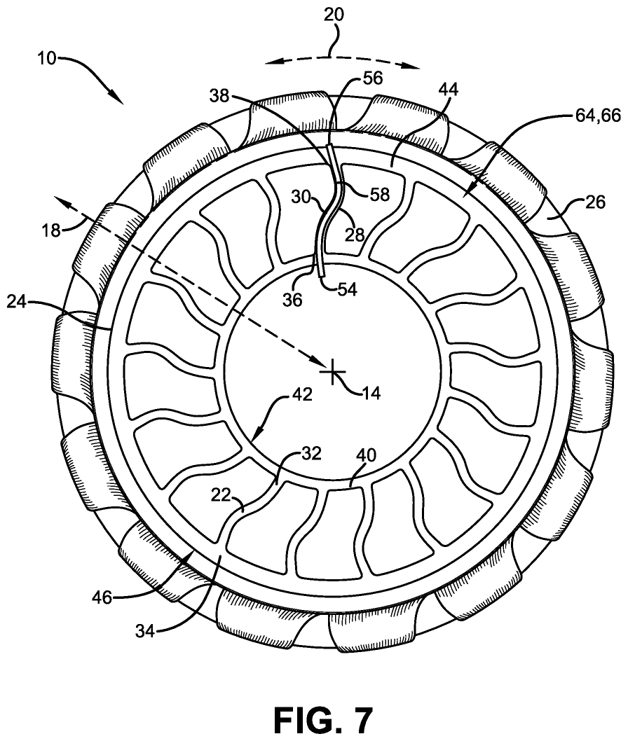

As shown in FIG. 7, the example non-pneumatic tire 10 may include a supporting structure 22 with an inner interface ring 40, a plurality of spokes 28, and an outer interface ring 44. The static discharge element 30 may be an elastic electrically conductive tape 58 through which electricity may be conducted. The elastic electrically conductive tape 58 may be located on an axial face 64 of the supporting structure 22. The axial face 64 may be located at a terminal axial end 66 of the supporting structure 22 in the axial direction 16. As such, the elastic electrically conductive tape 58 may not be located in the interior of the supporting structure 22, but rather on the outer surface of the supporting structure 22. The elastic electrically conductive tape 58 may engage the hub 12 and extend across the inner interface ring 40, the spoke 28, and the outer interface ring 44 to the shear band 24 so that the tape extends across side faces of the shear band 24 and the hub 12 in the axial direction 16. Electricity from the hub 12 may thus be conducted through the elastic electrically conductive tape 58 and into the shear band 24. As a result, the spoke 28 may be constructed so that carbon black is not present in the portions of the spoke 28 outside of the elastic electrically conductive tape 58, and in some instances, may not be present at all in the spoke 28.

The elastic electrically conductive tape 58 may extends in the radial direction 18 and also change course in the circumferential direction 20 upon its extension outward in the radial direction 18. The elastic electrically conductive tape 58 may be applied to a mold surface before molding so that it is captured by the supporting structure 22. However, in other arrangements, the elastic electrically conductive tape 58 may be applied by adhesives or other means after formation of the supporting structure 22 and other elements of the non-pneumatic tire 10. The elastic electrically conductive tape 58 may stretch in one or more directions in order to accommodate deformation of the spoke 28 during normal use of the non-pneumatic tire 10.

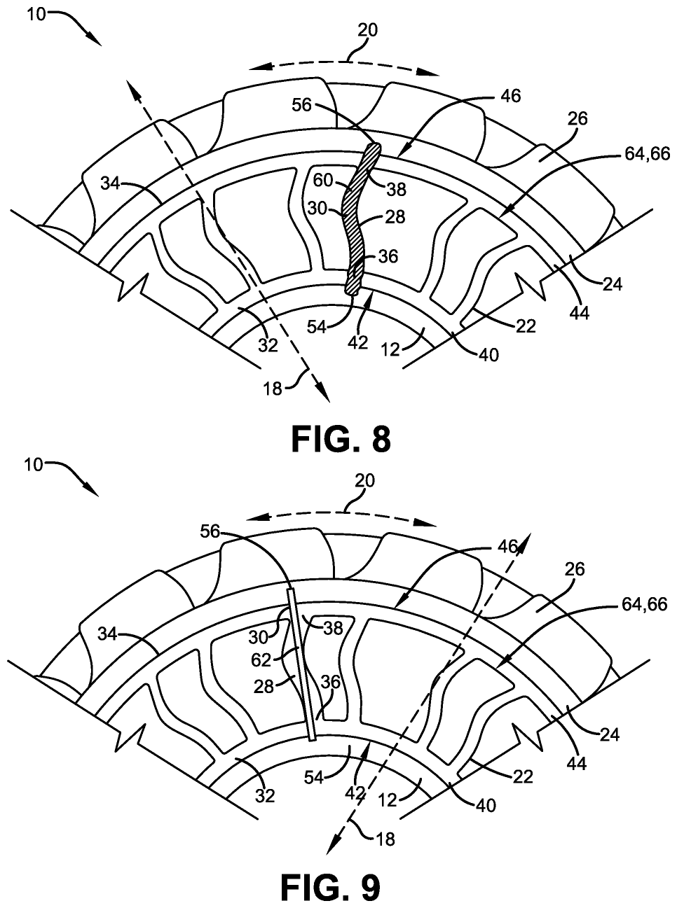

FIG. 8 shows an arc length portion of the non-pneumatic tire 10 in the circumferential direction 20. The supporting structure 22 again may have the inner interface ring 40, the spoke 28, and the outer interface ring 44. The static discharge element 30 may be electrically conductive paint 60 located on the axial face 64 of the supporting structure 22. The electrically conductive paint 60 also be located on an axial face of the hub 12 and on an axial face of the shear band 24. The electrically conductive paint 60 is thus not found on the interior of the supporting structure 22, but is on an outward facing exterior surface of the supporting structure 22. The electrically conductive paint 60 may be applied directly to the spoke 28, inner interface ring 40, and outer interface ring 44 subsequent to formation of these components. The electrically conductive paint 60 may also be applied to the shear band 24 and the hub 12 after they have been molded or otherwise formed. The electrically conductive paint 60 may alternatively be applied to a mold surface and then released during molding of the supporting structure 22. The electrically conductive paint 60 may be applied to an injection molded supporting structure 22 that does not have a release agent. The electrically conductive paint 60 may cover the entire terminal axial end 66 of the spoke 28, but not the entire terminal axial ends 66 of the inner and outer interface rings 40, 44, but only a portion of their terminal axial ends 66. The spoke 28 may be arranged so that carbon black is not present in portions of the spoke 28 outside of the electrically conductive paint 60, and the spoke may also be arranged so carbon black is not present at all either in the electrically conductive paint 60 or the portions of the spoke 28 outside of the electrically conductive paint 60.

FIG. 9 shows a supporting structure 22 with spokes 28, inner interface ring 40, and outer interface ring 44. The static discharge element 30 may be a strip of electrically conductive polymer 62. The supporting structure 22 and electrically conductive polymer 62 may be formed by a two shot injection molding process. A first shot applies the strip of electrically conductive polymer 62 onto the mold surface between the hub 12 and the shear band 24. A second shot completes the mold assembly by injecting the inner interface ring 40, spokes 28, and outer interface ring 44. The electrically conductive polymer 62 may thereby be captured by the spoke 28. The electrically conductive polymer 62 may abut the first terminal end 42 and the second terminal end 46 to put the electrically conductive polymer 62 into electrical communication with the hub 12 and the shear band 24. The end 54 of the electrically conductive polymer 62 may overlay the exterior surface of the hub 12 and the end 56 may overlay a side of the shear band 24 to allow electricity to transfer into the shear band 24. The electrically conductive polymer 62 may extend in a generally straight orientation in the radial direction 18 as shown, but it is to be understood that the electrically conductive polymer 62 may flex some degree in the circumferential direction 20 during operational flexing of the spoke 28. The spoke 28 may be provided so that carbon black is not present in portions of the spoke outside of the electrically conductive polymer 62, and may alternatively be arranged so that carbon black is not present at all in the electrically conductive polymer 62 or in the portions of the spoke 28 other than the electrically conductive polymer 62.

Although the various embodiments have been described as lacking carbon black in the portions of the spoke 28 outside of the static discharge element 30, it is to be understood that carbon black could in fact be present in the portions of the spoke 28 that are not the static discharge element 30 in other examples of the non-pneumatic tire 10. Examples discussed above may also have a single static discharge element 30 incorporated into the non-pneumatic tire 10. It is to be understood that additional examples are possible in which multiple static discharge elements 30 are present on the non-pneumatic tire 10. For example, from 2-4, from 5-7, or up to 10 static discharge elements 30 may be present. One of, or multiple, spokes 28 may have the various static discharge elements 30, and in some instances, all of the spokes 28 of the tire 10 may have a static discharge element 30. Also, although some of the above discussed examples have the static discharge element 30 located on a single axial face 64 of the supporting structure 22, other examples may include the opposite axial face of the supporting structure 22 likewise having one or more of the static discharge elements 30. Still further, it is to be understood that when more than one static discharge element 30 may be present in the tire 10. The static discharge elements 30 may all be of the same type or may be of different types.

For example, the non-pneumatic tire 10 may include both a filament 48 and filament fibers 68. In other examples, the non-pneumatic tire 10 may have static discharge elements 30 that are filaments 48, elastic electrically conductive tape 58, and electrically conductive paint 60. As discussed above, the spokes 28 and the variously discussed static discharge elements 30 may be capable of deflecting/stretching. The static discharge element 30 may be able to elongate 10 percent, and in other instances the elongation of the static discharge element 30 may be from 5-15 percent, from 8-12 percent, from 9-11 percent, from 10-13 percent, from 10-15 percent, from 15-25 percent, up to 30 percent, up to 40 percent, or up to 50 percent. The spokes 28 may be able to elongate the same amount as the static discharge elements 30 so that, for instance, both the spoke 28 and the static discharge element 30 carried by the spoke 28 may withstand an elongation during operation of up to 10 percent. The static discharge element 30 may be able to elongate a greater degree than the other portions of the supporting structure 22, such as portions of the spoke 28 that are not the static discharge element 30 in which the supporting structure 22 does in fact include a spoke 28.

In accordance with the present invention, conductive ink may advantageously replace the above described static discharge elements 30 and provide a conductive path for a substrate with up to 50 percent strain applied to it. Greater than 50 percent strain may lessen the electrical conductivity. The conductive ink may thereby dissipate the static electricity from the vehicle through the rotating, stressed tire (pneumatic and non-pneumatic) to the ground contact surface. As described above, a conductive pathway is especially needed in tires with little to no conductive materials where the structure of the tire does not provide a reliable path for static electricity to dissipate.

Conductive inks may be prepared with different compositions of silver and carbon particles and may be evaluated in terms of resistance, strain sensitivity, response linearity, and device fabrication repeatability. This approach leads to low-cost fabrication of highly sensitive, but easy to handle, conductive inks (e.g., strain sensors, resistors, capacitors, etc.). By varying composition of two inks having large differences in conductivity, a large strain sensitivity may be achieved near a percolation threshold, but not so close to percolation threshold as to sacrifice repeatability of ink fabrication. Observed changes in electrical resistance with ink composition may be gradual, thereby allowing for better manufacturing control of sensitivity and repeatability of performance for application as static discharge element(s) in tires.

In a pneumatic tire, typically a chimney is used to provide a path for static electricity to dissipate. A chimney is a compound formulated to allow electricity to pass through inside a pneumatic tire. The conductive ink may be used instead of the chimney in a pneumatic tire at the tread splice or other areas during the building process to provide a smaller simpler path for electricity to discharge. The conductive ink may thereby eliminate the need for a separate compound to be included with the tread during tire building (e.g., reduce complexity and cost, etc.).

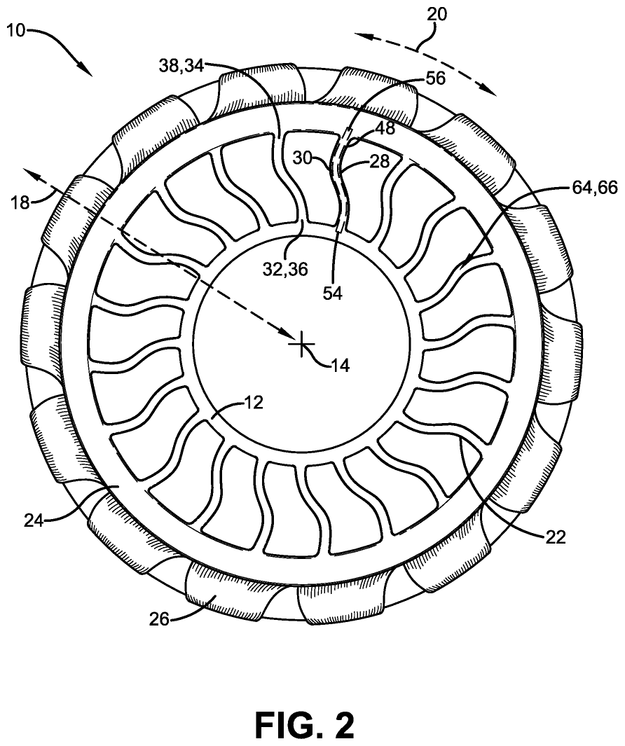

A non-pneumatic tire typically includes a shearband, a connecting structure, and a wheel. The connecting structure may have no electrical conductivity. The conductive ink may be applied to the shearband, connecting structure, and the wheel collectively to create a path for the discharge of electricity The conductive ink may thereby eliminate the need for internal and/or external methods of dissipating static electricity (FIGS. 1 through 9).

While the present invention has been described in connection with certain preferred examples, it is to be understood that the subject matter encompassed by way of the present invention is not to be limited to those specific examples. On the contrary, it is intended for the subject matter of the present invention to include all alternatives, modifications, and/or equivalents as may be included within the spirit and scope of the following claims.

What is claimed:

1. A tire comprising
a cylindrical hub with a central axis;
an annular supporting structure disposed radially outward from the hub;
an annular shearband disposed radially outward from the supporting structure;
an annular tread disposed radially outward from the shear band; and
a conductive ink collectively applied to the shearband, supporting structure, and the hub to create a path for the discharge of electricity through the conductive ink, the conductive ink providing a substrate for conducting electricity with up to 50 percent strain applied to the substrate.

2. The tire as set forth in claim 1 wherein the conductive ink includes silver particles.

3. The tire as set forth in claim 1 wherein the conductive ink includes carbon particles.

4. The tire as set forth in claim 1 wherein the conductive ink includes carbon and silver particles.

5. A tire comprising
a cylindrical wheel with a central axis;
at least two sidewall structures disposed radially outward from the hub;
an annular belt package disposed radially outward from the sidewall structures;
an annular tread disposed radially outward from the belt package; and
a conductive ink collectively applied to the belt package, both sidewall structures, and the wheel to create a path for the discharge of electricity through the conductive ink, the conductive ink providing a substrate for conducting electricity with up to 50 percent strain applied to the substrate.

6. The tire as set forth in claim 5 wherein the conductive ink includes silver particles.

7. The tire as set forth in claim 5 wherein the conductive ink includes carbon particles.

8. The tire as set forth in claim 5 wherein the conductive ink includes carbon and silver particles.
